(19) United States
(12) Patent Application Publication
(10) Pub. No.: US 2014/0197687 A1
(43) Pub. Date: Jul. 17, 2014

(54) WIRELESS POWER SUPPLY SYSTEM FOR SUPPORTING MULTI REMOTE DEVICES

(71) Applicant: ESPOWER ELECTRONICS INC., New Taipei City (TW)

(72) Inventor: CHING-CHI LIN, KEELUNG CITY (TW)

(73) Assignee: ESPOWER ELECTRONICS INC., NEW TAIPEI CITY (TW)

(21) Appl. No.: 13/743,911

(22) Filed: Jan. 17, 2013

(51) Int. Cl. H02J 17/00

(52) U.S. Cl. CPC H02J 17/00
USPC 307/31

(57) ABSTRACT

A wireless power supply system for providing a wireless power adapted for multi remote devices. The wireless power supply system comprises a plurality of primary coils, a wireless communication receiver, and a controller. The wireless communication receiver is used for receiving power requirement information. The controller is used for selecting one of the primary coils to transmit the wireless power in accordance with its internal program. When a specific remote device of the remote devices is disposed to the position of the coils and the specific remote device sends a power identification signal, the wireless communication devices receives the power identification signal, and performs a decode procedure to obtain a decoded power identification signal, and the controller selects a specific primary coil of the primary coils to output a corresponding wireless power to the specific remote device in accordance with the decoded power identification signal.

### BACKGROUND OF THE INVENTION

1. Field of the Invention

The present invention relates to a wireless power supply system; in particular, to a wireless power supply system having a plurality of primary coils, and selecting according to the load state for supporting multi remote devices.

2. Description of Related Art

With lightweight and thin electronic device, users have been getting used to carry these electronic devices. General common electronic devices such as mobile phones, PDA (Personal Digital Assistance), notebook computers, tablet PCs, digital cameras and digital camcorders, etc., has been generally widely used for the community to become an integral part of modern information life.

The concept of providing wireless power supply system using the principle of electromagnetic induction in order to reduce wiring trouble of charging, in a multi-year before have been proposed. Due to the limitation of previous induction technology, wireless charging system is subject to restrictions. For example, in order to provide a reasonably efficient operation, the wireless charging system of the prior art need to close and accurate alignment between the primary coil and the second coil. Further, between the power supply device and remote devices requiring a high coordinated tuning. Different remote devices may require different amounts of power supply, these problems are more complicated.

Kuennen et al, U.S. Pat. No. 6,825,620, title of the invention for “Inductively Coupled Ballast Circuit”, Nov. 30, 2004, to be issued, discloses an inductive current supply system, with the ability to adjust its operation in response to a variety of load operation parameters. And incorporated herein by reference. U.S. patent application Ser. No. 11/965,085, the title of the invention “Inductive Power Supply with Device Identification” mentioned in the Dec. 27, 2007, reveals an inductive power supply system, which has identified the remote devices and their operation parameter.

Although the above technique has been significant improvements for related systems, but in certain applications, there is still a demand for greater flexibility. In particular, the application of wireless charging, limited to one-to-one applications. In other words, a mobile device must correspond to a specific wireless charging device. When the product is not the same, wireless charging device is not compatible. Therefore, the applicant proposed a wireless power supply system for supporting devices compatible with a plurality of product.

### SUMMARY OF THE INVENTION

The object of the present invention that provides a wireless power supply system for supporting multi remote devices. This wireless power supply system for supporting multi remote devices through the built-in multiple primary coils, further through wireless communication, to identify external products and electricity demand and switch the primary coil, achieving the purpose of a wireless power supply system for supporting multi remote devices is compatible with a plurality of product.

In order to achieve the aforementioned objects, according to an embodiment of the present invention, a wireless power supply system for supporting multi remote devices is proposed. This system is used to provide wireless power supply, and compatible with a plurality of remote devices. The wireless power supply system comprising a plurality of primary coils, a wireless communication receiver, and a controller. Each of the primary coils is able to wirelessly transmit the wireless electrical power to the remote devices. And the numbers of windings of the primary coils are different from each other. The wireless communication receiver is used for receiving power requirement information. The controller coupled to the wireless communication receiver and the primary coils. The controller is used for selecting at least one of the primary coils to transmit the wireless power in accordance with its internal program. When a specific remote device of the remote devices is disposed to the position of the coils and the specific remote device sends a power identification signal. The wireless communication devices receives the power identification signal, and performs a decode procedure to obtain a decoded power identification signal. And the controller selects a specific primary coil of the primary coils to output a corresponding wireless power to the specific remote device in accordance with the decoded power identification signal.

The spirit of the present invention through the built-in multiple primaries coils, and through wireless communications to identify external products and the demand for electricity that is used to switch the primary coils. When the external product through the wireless transmission, power requirements of the wireless power supply system for supporting multi remote devices of the present invention is proposed. The system will determine its power requirement, switching the appropriate primary coil, and charge corresponding to the electromagnetic field of the primary coil supply for the external product demand. When power requirements change, the external product is through wireless transmission of wireless power supply system for supporting multi remote devices of the present invention to propose a different power requirement. The wireless power supply system for supporting multi remote devices of the present invention according to the power requirement of the remote devices, switch the used primary coil, and an electromagnetic field corresponding to the power supply of this primary coil for charging the external product.

In order to further the understanding regarding the present invention, the following embodiments are provided along with illustrations to facilitate the disclosure of the present invention.

### BRIEF DESCRIPTION OF THE DRAWINGS

FIG. 1 shows a circuit diagram of a wireless power supply system for supporting multi remote devices according to a first embodiment of the present invention;

FIG. 2 shows a primary side circuit diagram of a wireless power supply system for supporting multi remote devices according to a second embodiment of the present invention;

FIG. 3 shows a secondary side circuit diagram of a wireless power supply system for supporting multi remote devices according to a third embodiment of the present invention;

FIG. 4 shows a gain information curve varying with frequency diagram of a wireless power supply system for supporting multi remote devices according to a fourth embodiment of the present invention;

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

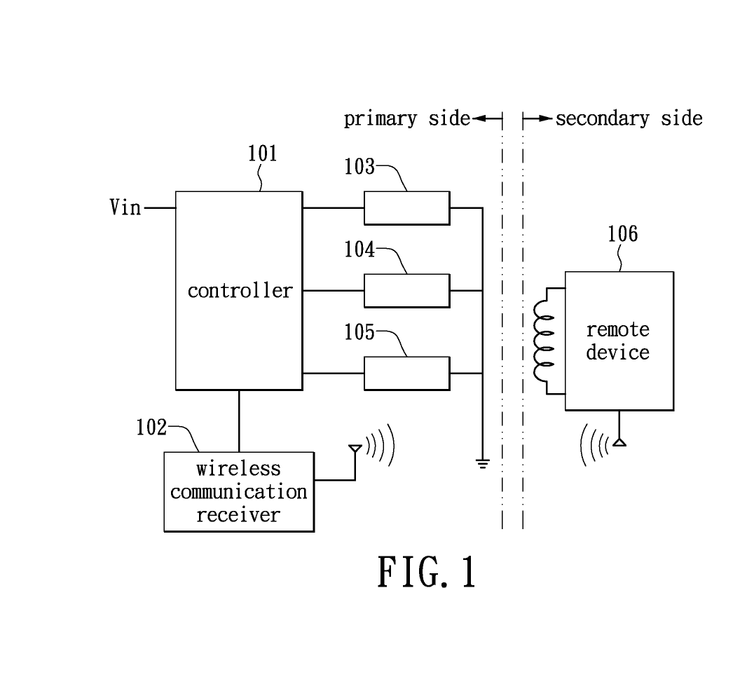

FIG. 1 shows a circuit diagram of a wireless power supply system for supporting multi remote devices according to a first embodiment of the present invention. This wireless power supply system for supporting multi remote devices comprising a controller 101, a wireless communication receiver 102, the first primary coil 103, the second primary coil 104, the third primary coil 105, and the remote device 106. The remote device 106 having a coil of primary side and a coil of secondary side. Magnetic field inductive charging circuit is using a coil. The electric field induction is using a additional lithographic. FIG. 1 is not showed as above-mentioned, but it does not mean that the present invention can not use the electric field induction to output wireless power.

Generally, the first primary coil 103, the second primary coil 104 and the third primary coil 105 may respectively correspond to the example as three kind of remote device 106 which is supported. Assumptions, the first remote device 106 has a first voltage demand, the second remote device 106 has a second voltage demand, and the third remote device 106 has a third voltage demand. Assuming to place remote device 106 is the second remote device. The second remote device through its internal wireless transmitter emits a power identification signal which having its machine model and its voltage requirements. Wireless communication receiver 102 will decode this power identification signal. Machine model and its second voltage demand will decoded into a data that controller 101 can recognize. In this way, the controller 101 can be based on this data, the selected second primary coil 104, and outputting the electromagnetic field to the second remote device 106 starts the charging behavior of the magnetic field induction.

In addition, the wireless communication receiver 102 can also serve as a feedback mechanism. Example to charge the battery. When the battery is low-power, it needs constant current charging and constant voltage charging when the battery is high-power. Through the second remote device 106 emits a load state, an embodiment of the present invention, the controller 101 of the example will have to appropriately adjust the internal power output. For example as the duty cycle of the pulse width modulation. Further, the above-described circumstances also can be appropriately adjusting primary coils. For example, the first primary coil 103 is a low-power coil, the second primary coil 104 is a medium-power coil, and the third primary coil 105 is a high-power coil. When the power demand is low, the controller 101 of the embodiment of the present invention may also switch the second primary coil 104 to the first primary coil 103 in order to output a power corresponding to the increased power efficiency.

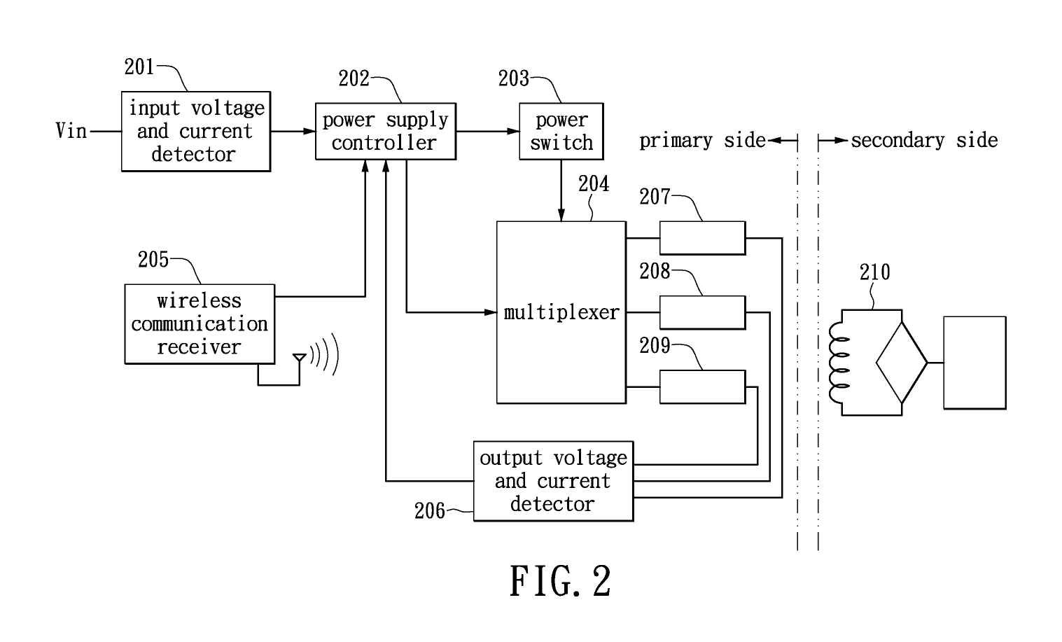

FIG. 2 shows a primary side circuit diagram of a wireless power supply system for supporting multi remote devices according to a second embodiment of the present invention. FIG. 2 only illustrating the primary side of the circuit diagram. The wireless power supply system for supporting multi remote devices which comprising an input voltage and current detector 201, a power supply controller 202, a power switch 203, a multiplexer 204, a wireless communication receiver 205, a output voltage and current detector 206, the first primary coil 207, the second primary coil 208 and the third primary coil 209. Further, the wireless power supply system additional illustrates the remote device 210 of secondary side.

Comparing FIG. 2 with FIG. 1, that can know the controller 101 is achieved by the input voltage and current detector 201, the power supply controller 202, the power switch 203, the multiplexer 204, and output voltage and current detector 206. Input voltage and current detector 201 is used for detecting the appropriateness of the input voltage and current. After recognizing, starting the power supply controller 202. The power supply controller 202 is above-mentioned peripheral circuit 201, 203, 204, 205, 206 control core. Assuming that the remote device 210 have not been configured to the specified position, the power supply controller 202 will make the several peripheral circuits 201, 203, 204, 205, 206 operating in the power saving mode.

When the remote device 210 is configured to the specified location, the wireless communication receiver 205 as in the first embodiment described manner to inform the power supply controller 202. The power supply controller 202 control the multiplexer 204 to choose one from the first primary coil 207, the second primary coil 208, and the third primary coil 209. Also assuming the primary coil which correspond to remote device 210 is the second primary coil 208. The multiplexer 204 is turned on the circuit between the power switch 203 and the second primary coil 208. Power supply controller 202 based on wireless communication receiver 205 for receiving the power demand control the duty cycle of the pulse width modulation signal of the power switch 203. And if there is necessary, the power supply controller 202 controls the multiplexer 204 to select another primary coil.

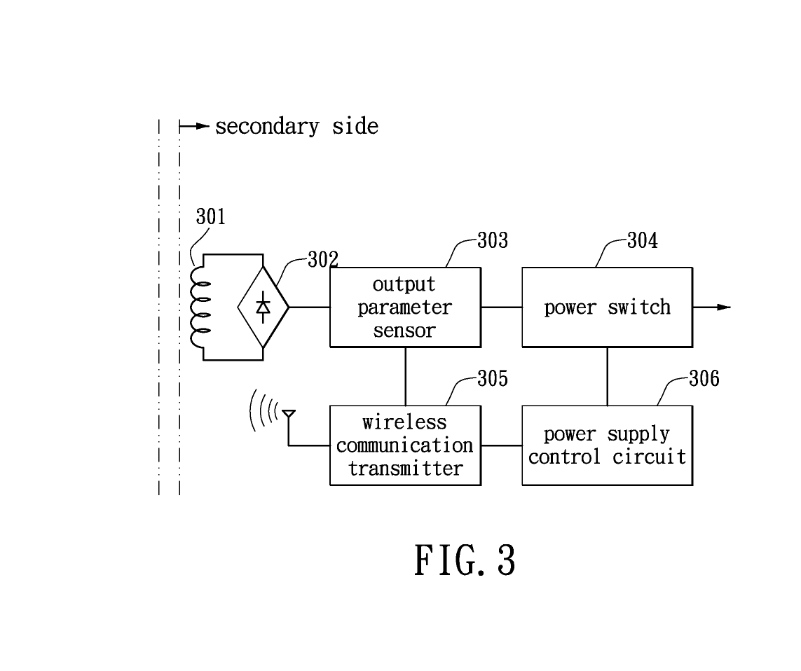

FIG. 3 shows a secondary side circuit diagram of a wireless power supply system for supporting multi remote devices according to a third embodiment of the present invention. Secondary side is called the remote device 210 circuit. Without accident, the architecture of each of the remote devices is substantially equivalent to this circuit of FIG. 3. The circuit of the secondary side comprises a secondary side coil 301, a rectifier circuit 302, an output parameter sensor 303, a power switch 304, and a wireless communication transmitter 305, and a power supply control circuit 306. If the remote device 210 is a device receiving the AC power, the rectifier circuit 302 is not necessary and can be ignored whose persons are known in the art.

Initially, the wireless communication transmitter 305 will send the model and information of voltage and current demand of remote device 210 to the primary side circuit. When the circuit of the primary side starts to operate, the secondary side coil 301 will start receiving the magnetic field, and this magnetic field is converted into the power supply, through the rectifier circuit 302 after rectification, and outputs a DC to output parameter sensor 303. Output parameter sensor 303 senses the power supply parameters after rectification, such as voltage, current or frequency, etc. The power supply parameters rectified by wireless communication transmitter 305 execute a wireless coding to obtain a power identification signal, transmit to wireless communication receiver of the primary side, execute a feedback control. Power supply control circuit 306 is based on the above mentioned power supply parameters, to control the power switch to supply battery power.

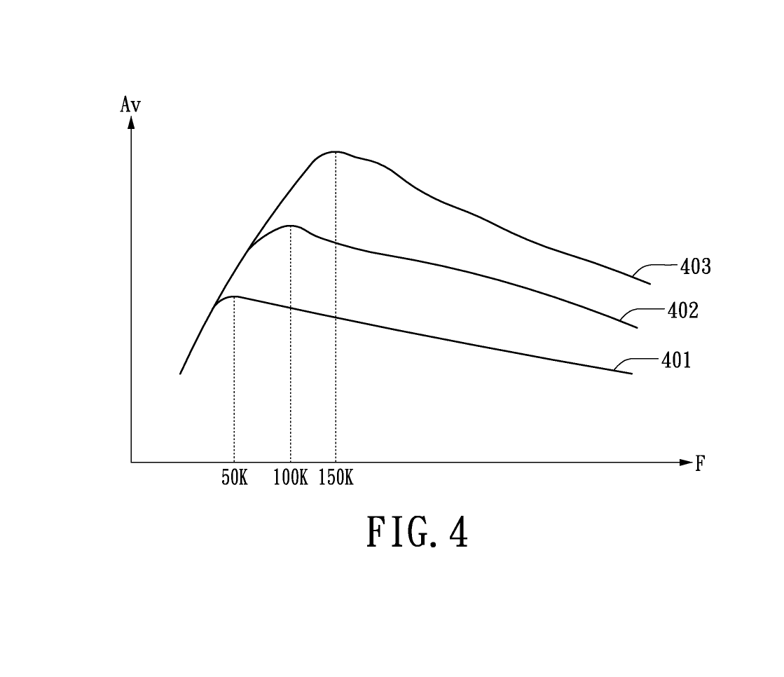

FIG. 4 shows a gain information curve varying with frequency diagram of a wireless power supply system for supporting multi remote devices according to a fourth embodiment of the present invention. Please also refer to FIG. 2 and FIG. 4, due to each coil have a gain information record varying with frequency, the gain information record varying with frequency is very important, and in order to maintain the stability of the power supply control. The gain information record varying with frequency 401 is assumed to correspond to the first primary coil 207, the gain information record varying with frequency 402 corresponds to the second primary coil 208, and the gain information record varying with frequency 403 corresponds to the third primary coil 209. The output voltage and the input voltage has the following relationship:

VO=VIN×AV×(MS/MP)×D

VO represents the output voltage, VIN represents the input voltage, AV represents the gain of the vertical axis of FIG. 4 described above, (MS/MP) represents the ratio of the number of coil of primary and secondary side, D represents the duty cycle. FIG. 4 shows the relationship between the gain AV and frequency. The gain information record varying with frequency 401˜403 respectively correspond to the coil current and voltage corresponding to the gain information record varying with frequency. Generally, in order to maintain the control stability and avoiding the generation of the zero, selecting the control frequency is in the right half portion of the gain peak. The output voltage and current detector 206 is used to detect the output voltage and current. The power supply controller 202 store the data of the gain information record varying with frequency. When the output voltage and current detector 206 detects the output voltage and current, back to the power supply controller 202. Power supply controller 202 will select one of the curves based on the voltage and current and the frequency of the pulse width modulation signal set at a stable frequency which increases the control stability of the wireless power supply system for supporting multi remote devices.

Sum upon, the spirit of the present invention through the built-in multiple primary coil and wireless communication to identify external products and the electricity demand for switching the primary coil. When the external product through the wireless transmission to propose a power requirement, the wireless power supply system for supporting multi remote devices of the present invention will determine its power requirement, switching the appropriate primary coil, and supply the electromagnetic field corresponding to this primary coil for the external product demand. When power requirements change, the external product through wireless transmission to propose different power requirement to the wireless power supply system for supporting multi remote devices of the present invention. The wireless power supply system for supporting multi remote devices of the present invention according to the power requirement change the primary coil, and an electromagnetic field corresponding to the primary coil for charging the external products.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A wireless power supply system, providing a wireless electrical power adapted for a plurality of remote devices, the system comprising:
a plurality of primary coils, wherein each of the primary coils is able to wirelessly transmit the wireless electrical power to the remote devices, the numbers of windings of the primary coils are different from each other;
a wireless communication receiver, receiving a power requirement information; and
a controller, coupled to the wireless communication receiver and the primary coils, selecting at least one of the primary coils to wirelessly transmit the wireless electrical power in accordance with its internal program;
Wherein when a specific remote device of the remote devices is disposed to the position of the primary coils and the specific remote device sends a power identification signal, the wireless communication receiver receives the power identification signal, and performs a decode procedure to obtain a decoded power identification signal, and the controller selects a specific primary coil of the primary coils to output a corresponding wireless electrical power to the specific remote device in accordance with the decoded power identification signal.

2. The wireless power supply system according to claim 1, wherein the primary coils comprising:
a low power coil;
a medium power coil; and
a high power coil.

3. The wireless power supply system according to claim 2, wherein the remote device comprising:
a secondary side induction coil;
a rectifier circuit, coupled to the secondary side induction coil;
an output parameter sensor, coupled to the rectifier circuit, detecting the power parameters being rectified; and
a wireless communication transmitter, coupled to the output parameter sensor, encoding the rectified power supply parameters, to a wireless identification signal for transmitting to the wireless communication receiver.

4. The wireless power supply system according to claim 3, wherein the power parameters sensed by the output parameter sensor is selected from the group consisting of voltage, current and frequency.

5. The wireless power supply system according to claim 3, wherein the remote device comprising:
a power switch, coupled to the rectifier circuit;
a battery, coupled to the power switch; and
a power supply control circuit, coupled to the power switch, controlling the power switch to control the charging of the battery.

6. The wireless power supply system according to claim 1, wherein the controller comprising:
an input voltage and current detector, receiving an input voltage, and detecting the input voltage and input current;
a multiplexer, coupled to the first end of each of the primary coils;
a power switch, coupled to the multiplexer;
an output voltage and current detector, coupled to the second end of each of the primary coils, detecting the voltage or current of the selected primary coils, to output a frequency selecting signal; and
a power supply controller, coupled to the input voltage and current detector, the output voltage and current detector, the multiplexer, the power switch, and the wireless communication receiver, the power supply controller controls the multiplexer to select the specific primary coil and controls the power switch to control the output power according to the received power identification signal decoded by the wireless communication receiver,
the power supply controller selects a stable frequency as the switching frequency of the power switch in accordance with the frequency select signal.

7. The wireless power supply system according to claim 6, wherein the power supply controller is stored with a plurality of gain information records varying with frequency corresponding to the output current and output voltage, the number of the gain information records is the same as to the number of the primary coils, when the power supply controller receives the frequency selecting signal, selecting one of the gain information records based on current and voltage information of the frequency selecting signal, and selects the stable frequency according to the selected gain information record.
